(19) United States
(12) Patent Application Publication
(10) Pub. No.: US 2025/0061374 A1
(43) Pub. Date: Feb. 20, 2025

(54) INTELLIGENT EVENT PREDICTION AND VISUALIZATION

(71) Applicant: INTERNATIONAL BUSINESS MACHINES CORPORATION, Armonk, NY (US)

(72) Inventors: Andre Felipe P LOPES, Jacarei (BR); Ana Paula APPEL, Sao Paulo (BR); Manuel Soares Pereira da Rocha JUNIOR, Barueri (BR); Luiz Carlos FARAY DE AQUINO, Sao Paulo (BR)

(21) Appl. No.: 18/449,735

(22) Filed: Aug. 15, 2023

(51) Int. Cl. G06N 20/00

(52) U.S. Cl. CPC G06N 20/00

(57) ABSTRACT

Computer implemented methods, systems, and computer program products include program code executing on a processor(s) obtains, via a client, an order for a service to be performed at a physical location. The program code verifies data comprising the order. The program code continuously obtains complementary data to the verified order data including satellite images relevant to the physical location. The program code continuously applies one or more machine learning models, to input comprising the complementary data and the verified order data, to produce output comprising one or more indicators that the order will be cancelled before the service is performed. The program code transmits the indicators to a classifier which generates a prediction at a threshold probability that the order will be cancelled before the service is performed (or not). The program code continuously generates or updates a dashboard to reflect a predicted cancellation status of the order.

### BACKGROUND

The present invention relates generally to the field of data machine learning for accurate prediction and visualization of events particularly in the area of data integrity in consumer systems.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Natural language understanding (NLU) uses deep learning to extract meaning and metadata from unstructured text data. For example, NLU can be used to extract categories, classification, entities, keywords, sentiment, emotion, relations and/or syntax from text. NLU capabilities can be implemented as a machine learning system that can include a neural network (NN). NLU technologies can utilize supervised, semi-supervised, or unsupervised deep learning through a single- or multi-layer NN to classify data. The deep learning capabilities use the NN to identify and weight connections between data points. The use of deep learning, including in NLU, is understood as a form of artificial intelligence. A subset of NLU is natural language processing (NLP). NLP is a subfield of AI and computer science that focuses on the tokenization of data and specifically, the parsing of human language, whether spoken or text, into its elemental pieces.

Robotic process automation (RPA), also referred to as software robotics, is a form of business process automation that is based on software robots (bots) or artificial intelligence (AI) agents. RPA differs from traditional workflow automation. With traditional software automation tools, a software developer produces a list of actions to automate a task and interface to the back end system using internal application programming interfaces (APIs) or dedicated scripting language. Meanwhile, RPA systems develop the action list by watching the user perform that task in the application's graphical user interface (GUI) and then perform the automation by repeating those tasks directly in the GUI. Utilizing RPAs can lower a barrier to the use of automation in products that might not otherwise feature APIs for this purpose. A common use of RPAs is to automate interactions with the GUI. RPA tools allow data to be handled in and between multiple applications, for instance, receiving email containing an invoice, extracting the data, and then typing that into a bookkeeping system.

Computer vision (CV) is a field of AI that enables computers and systems to derive meaningful information from digital images, videos and other visual inputs. CV models take actions and/or make recommendations based on these inputs. CV models are represented as providing a “computer vision” that enables computing systems to see, observe and understand. Examples of CV include image recognition, visual recognition, and facial recognition.

### SUMMARY

Shortcomings of the prior art are overcome, and additional advantages are provided through the provision of a computer-implemented method for predicting whether orders will be cancelled before they are completed. The method can include: obtaining, by one or more processors, via a client, an order for a service to be performed at a physical location; verifying, by the one or more processors, data comprising the order; continuously obtaining, by the one or more processors, complementary data to the verified order data, wherein the complementary data comprises satellite images of one or more locations relevant to the physical location; continuously applying, by the one or more processors, one or more machine learning models, to input comprising the complementary data and the verified order data, to produce output comprising one or more indicators that the order will be cancelled before the service is performed; based on obtaining the output, continuously transmitting, by the one or more processors the one or more indicators to a classifier; continuously applying, by the one or more processors, the classifier to generate a prediction at a threshold probability, based on the one or more indicators, that the order will be cancelled before the service is performed; and continuously generating or updating, by the one or more processors, a graphical user interface comprising a dashboard on a display accessible to the one or more processors, to reflect a status of the order, wherein the status comprises the determination of the classifier.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a workflow that provides an overview of various aspects performed by the program code (executing on one or more processors) in some embodiments of the present disclosure;

FIG. 3 is an example of a machine learning training system that can be utilized to perform cognitive analyses of the text to classify the emotions as either positive or negative emotions in embodiments of the present invention; and

FIG. 4 provides a view of functionality of various aspects of the embodiments described herein.

### DETAILED DESCRIPTION

Embodiments of the present invention combine AI, specifically, machine learning, and RPAs in a whole (digital) sales pipeline to enable program code executing on one or more processors to monitor sales orders to reduce consumer fraud and/or increase processing efficiencies (both computing resources and natural resources) by predicting if these sales orders have a high probability of being cancelled. A specific practical application to which certain examples are directed to is for telecommunications companies where the program code in these examples determines whether orders placed have a high probability of being cancelled prior installation at a customer's address. The utility of this application is realized because orders placed for telecommunications services have a high rate of cancellation and processing resources (e.g., telecommunications infrastructure resources), human resources (e.g., workforce), and natural resources (e.g., gas, etc.) and efficiencies can be increased when the program code can determine whether an order has a high probability of being cancelled before resources are deployed to address the order. Additionally, the program code can help prevent consumer fraud in these order systems. Although the practical application of the systems, methods, and computer program products described herein to telecommunications order systems is described throughout, this is a non-limiting example that it provided for illustrative purposes and to demonstrates the utility of these examples for a given purpose. These examples can be applied to prevent fraud and to conserve resources in other types of order entry systems.

The improvement of telecommunications order entry systems is a practical application for examples described herein at least because sales orders in these systems are cancelled at a rate that is high enough to impact efficacy and efficiency. In some cases, in telecommunications order entry systems, an average of 20% of the sales orders are cancelled during the time window between the first sales contact and the moment of final installation at the customer's address. Reasons for these cancellations include, but are not limited to, inconsistent data about the customer and the installation address, limited information technology (IT) infrastructure from the company side, and/or urbanization and/or geographical characteristics of the installation location. In embodiments of the present invention, the program code can utilize machine learning and RPMs to anticipate these issues and to improve resource management and distribution and improve efficacy and efficiency of the telecommunications entity.

Embodiments of the present invention include computer-implemented methods, computer systems, and computer program products that comprise program code that (intelligently) monitors and predicts if sales orders (also referred to as requests) have a high probability of being cancelled prior to fulfillment. As aforementioned, the examples herein can be used specifically (but not exclusively) by telecommunications entities to monitor and predict if sales orders have a high probability of being cancelled prior to installation of the ordered service at the customer's address. To monitor, update, and predict the probability of order cancellation throughout the sales pipeline (e.g., during the lifecycle from order entry to delivery or cancellation), in real-time or near real-time, the program code utilizes both RPAs as well as machine learning models. The program code can utilize data from various sources accessible to and/or communicatively coupled to the one or more processors in monitoring and predicting order progression, including but not limited to information technology (IT) infrastructure data, client data, geographic information system (GIS), and/or historical data related to past sales. As will be discussed in greater detail herein, the program code checks the orders it received for correctness, evaluates external factors that could affect the ability to install an ordered service, and predicts a probability of a given sales order being cancelled based on at least these factors.

Embodiments of the present invention are inextricably linked to computing and the elements comprising these embodiments are integrated into a practical application. The practical application of intelligently monitoring and predicting if sales orders have a high probability of being cancelled prior to fulfillment is discussed above. However, in order to realize this practical application, the computer-implemented methods, systems, and computer program products utilize (and are enabled by) a computing infrastructure that can include, in various examples, RPAs, application programming interfaces (APIs) and crawlers to interact with external data, cognitive assistants (Chatbots) to address inconsistent data, and machine learning algorithms to predict the probability of a given sales order being cancelled prior installation. The program code applies one or more machine learning algorithms to monitor and update this probability, in-real time (or near real-time) throughout the lifecycle of the order. The program code also generates and updates a dashboard to reflect any changes in probability, to a user, via a graphical user interface (GUI). Thus, the program code utilizes a computing infrastructure to continuously determine a probability of cancellation for each order placed throughout the lifecycle of the order and this functionality is enabled by the combination of computing technologies. Thus, the data integrity of the orders and the efficiency of the system and the practical application it supports are inextricably tied to computing.

The examples herein provide significant advantages over existing approaches to improving efficiencies in order fulfillment systems. One such advantage is that machine learning algorithms utilized in embodiments of the present invention to classify orders are likely to be cancelled can be trained utilizing data maintained internally by the company taking the orders (e.g., the telecommunications company). The program code in embodiments of the present invention can utilize the algorithms trained using these data to determine, as early as a first contact with a prospective customer, whether an order is more likely than not to be cancelled before fulfillment. Because the program code in embodiments of the present invention can monitor and update predictions related to the cancellation of orders as they move through the sales pipeline, the program code can determine that a cancellation is likely to occur before the actual installation on site. In addition to training algorithms with existing customer data, program code in embodiments of the present invention also mines other data sources for data to assist in predicting whether orders will be cancelled. Although some existing approaches utilize external data sources, such as social media, to predict or to analyze customer churn trends, these approaches do not utilize these data to train machine learning algorithms to predict order cancellations. Predicting whether an order is cancelled is a significant improvement because it impacts resource efficiency. Embodiments of the present invention also provide a significant improvement by utilizing telecommunications infrastructure data and/or bandwidth and port availability to determine the viability for new (ordered) installations, as part of determining whether an order in likely to be cancelled. Existing technologies utilize data for network traffic predictions and not to determine the viability of infrastructure to support service ordered or to identify data mismatches on the sales orders information. Thus, embodiments of the present invention provide a novel approach at least to data mining and utilization of these data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

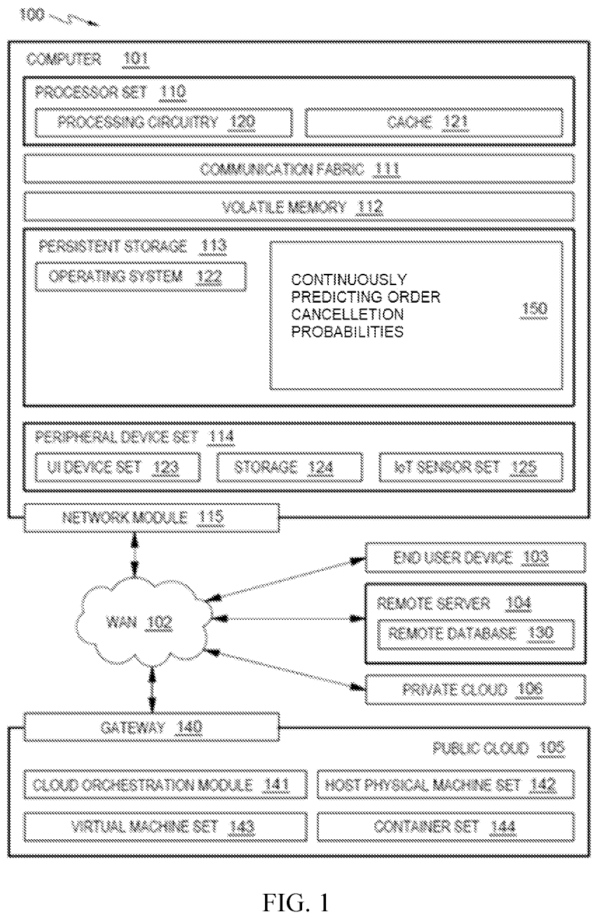

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for continuously predicting order cancellation probabilities 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

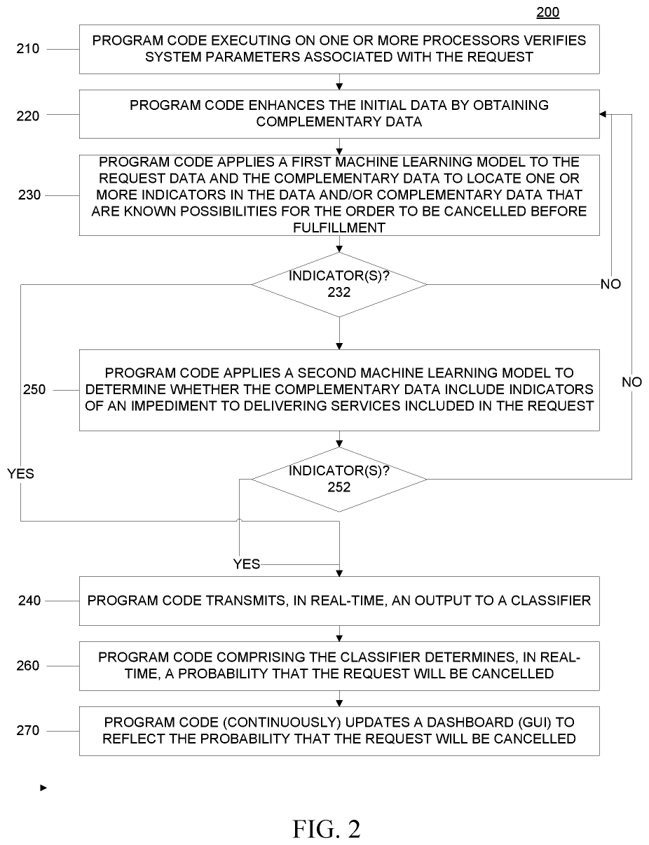

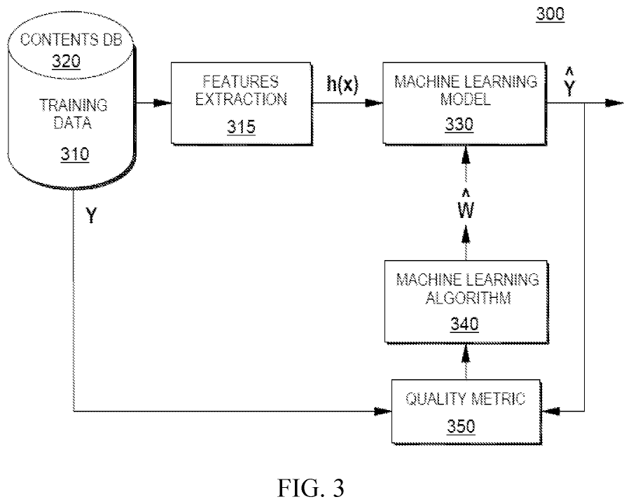

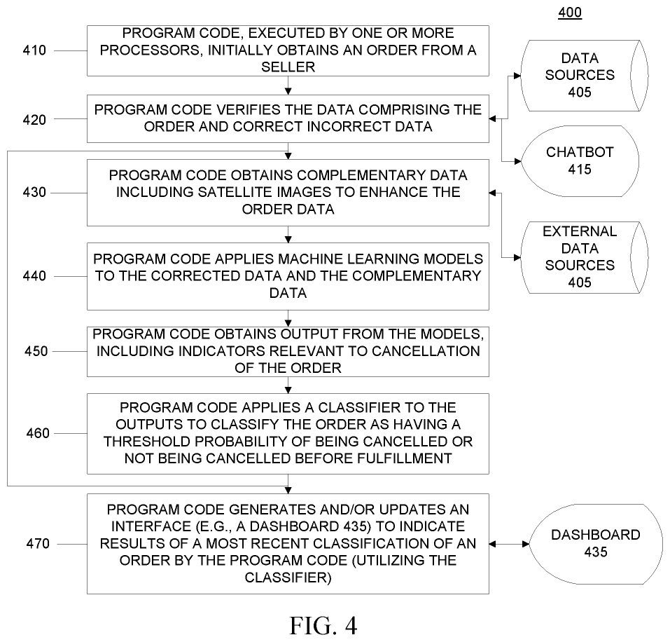

As will be described in further detail herein, the computer-implemented methods, computer systems, and computer program products described herein include program code executing on one or more processors that manages requests by utilizing a combination of machine learning algorithms and RPMs to determine a probability that each request will be cancelled. FIGS. 2-4 illustrates various aspects of the examples. While FIGS. 2 and 4 illustrate aspects of more general workflows 200 400, FIG. 3 illustrates various machine learning aspects of some examples, herein, including a use of a classifier by program code executed on one or more processors. Some embodiments of the present invention train and apply more than one machine learning model to determine whether orders will be cancelled before fulfillment (e.g., on-site installation). Some examples herein also incorporate the use of neural networks, including convolutional neural networks, and a classier (e.g., FIG. 3), which can utilize a deep learning model. These aspects are discussed below and in the context of the workflows of FIGS. 2 and 4.

Neural networks refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification.

A convolutional neural network (CNN) is a class of neural network. CNNs utilize feed-forward artificial neural networks and are most commonly applied to analyzing visual imagery. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process images, such as the satellite images processed by the program code and a machine learning model in the examples described herein, as very high number of neurons would be necessary, due to the very large input sizes associated with images. Utilizing a CNN addresses this issue as it reduces the number of free parameters, allowing the network to be deeper with fewer parameters, as regardless of image size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale (image) recognition systems, giving state-of-the-art results in segmentation, object detection and object retrieval. CNNs can be of any number of dimensions, but most existing CNNs are two-dimensional and process single images. These images contain pixels in a two-dimensional (2D) space (length, width) that are processed through a set of two-dimensional filters in order to understand what set of pixels best correspond to the final output classification. A three-dimensional CNN (3D-CNN) is an extension of the more traditional two-dimensional CNN and a 3D-CNN is typically used in problems related to video classification. 3D-CNNs accept multiple images, often sequential image frames of a video, and use 3D filters to understand the 3D set of pixels that are presented to it. In the present context, as discussed herein, images provided to a CNN include satellite images from weather satellites.

A classifier, which is illustrated in FIG. 3, can be comprised of various cognitive algorithms, AI instruction sets, and/or machine learning algorithms. Classifiers can include, but are not limited to, deep learning models (e.g., neural networks having many layers) and random forests models. Classifiers classify items (data, metadata, objects, etc.) into groups, based on relationships between data elements in the metadata from the records. In some embodiments of the present invention, the program code can utilize the frequency of occurrences of features in mutual information to identify orders with a high probability of being cancelled. In general, program code utilizes a classifier to create a boundary between data of a first quality data of a second quality, in the context of the examples herein, orders that are likely to be cancelled and orders that are unlikely to be cancelled. As a classifier is continuously utilized, its accuracy can increase as testing the classifier tunes its accuracy. When training a classifier, in some examples, program code feeds a pre-existing feature set describing features of metadata and/or data into the one or more cognitive analysis algorithms that are being trained. The program code trains the classifier to classify records based on the presence or absence of a given condition, which is known before the tuning. The presence or absence of the condition is not noted explicitly in the records of the data set. When classifying a source as providing data of a given condition (based on the metadata), utilizing the classifier, the program code can indicate a probability of a given condition with a rating on a scale, for example, between 0 and 1, where 1 would indicate a definitive presence. The classifications need not be binary and can also be values in an established scale.

A deep learning model can refer to a type of classifier. A deep learning model can be implemented in various forms such as by a neural network (e.g., a convolutional neural network). In some examples, a deep learning mode includes multiple layers, each layer comprising multiple processing nodes. In some examples, the layers process in sequence, with nodes of layers closer to the model input layer processing before nodes of layers closer to the model output. Thus, layers feed to the next. Interior nodes are often “hidden” in the sense that their input and output values are not visible outside the model.

FIG. 2 is a workflow 200 that illustrates various aspects of some embodiments of some examples herein. FIG. 2 includes two machine learning models (generated by training machine learning algorithms). In this example, program code executed by one or more processors applies the first machine learning model to determine whether data submitted in a request and complementing the request are predictive that the order will be cancelled before fulfillment. The program code applies the second machine learning model to determine whether circumstances outside of the order data (and complementary data related to the order data) are predictive that the order will be cancelled before fulfillment. Although FIG. 2 and FIG. 4 (which is discussed later) refer to the machine learning models as being first and second and illustrate the program code applying the models sequentially, this arrangement is provided for illustrative purposes only. The models can be provided in any order, asynchronously, and/or simultaneously. The workflows separate the program code applying the models into separate events for clarity of the illustration only, and not to impose any limitations on the ordering, synchronicity, or asynchronicity of the program code applying the models.

As illustrated in FIG. 2, in some examples, in response to receiving a request (e.g., order for services) by a system, program code executing on one or more processors verifies system parameters associated with the request (210). The parameters that the program code verifies can include the location which would be serviced by fulfilling the request and the availability for servicing (of resources and/or of the requestor). The program code can determine whether data associated with the request is correct using a repository containing information including infrastructure data, client data, sales data, and historical service data. Once the program code determines that a portion of the data is incorrect and/or incomplete, the program code can enhance the initial data by obtaining complementary data by using one or more method including, but not limited to, prompting the client for additional data, and/or obtaining data associated with the client (associated with the request) from other data sources, including but not limited to, social networks, government data, a development index, weather forecast/alerts, satellite images, and/or geographic information system data (220). In some examples, the program code utilizes the complementary data to verify and/or complete aspects of the data in a request. In verifying and completing the request data, the program code can utilize one or more of RPAs, APIs, and/or crawlers to interact with external data.

Once the program code has obtained the complementary data the program code applies a first machine learning model to the request data and the complementary data to locate one or more indicators in the data and/or complementary data that are known (e.g., labeled) possibilities for the order to be cancelled before fulfillment (230, 232). The program code can determine, with the machine learning model, whether the request raises an alert. In some examples, the machine learning model was trained using historical data, including but not limited historical customer orders and thus, by applying the machine learning model, the program code can recognize patterns in the data that would indicate a probability (e.g., at a predetermined threshold) that the order will be cancelled, based on the progression of past orders with these patterns. The program code can determine that an alert is relevant based on querying the request data and the complementary data for predetermined keywords. Based on determining that the data and the complementary data indicates one or more known possibilities for the order to be cancelled before fulfillment (e.g., raises an alert), the program code transmits, in real-time, a (first) output to a classifier (240). The output can be a binary feature. If there are no indicators, the program code can continue to obtain complementary data and apply the machine learning model until such as time as there is an indicator. As will be discussed below, the program code can also apply a second machine learning model. In this example, the program code applies the second machine learning model to the input regardless of the result of the application of the first machine learning model. However, in some examples, the models can be applied in a different sequence or simultaneously and based on a specific result (output) from each model. For example, in some examples, if there is no indicator based on the data or complementary data from the first machine learning model, only then will the second machine learning model be applied by the program code. An example of a multi-threaded evaluation of the data and/or complementary data is illustrated in FIG. 2.

As aforementioned, the program code employs a second machine learning model to determine whether there are circumstances outside of the order data and some of the complementary data that create a probability that the order will be cancelled. As illustrated in FIG. 2, the program code obtains data related to environmental conditions at a location where the order would be fulfilled (e.g., where services would be rendered) as part of the complementary data (220). The environmental conditions can include, but are not limited to, satellite images. Based on obtaining the data related to environmental conditions, the program code applies a second machine learning model to determine whether the complementary data (e.g., the satellite images) include indicators of an impediment to delivering services included in the request.

Program code applies the second machine learning model to determine whether the environmental conditions include one or more environmental impediment condition to installation of services included in the request (250, 252). Based on the second machine learning model outputting at least one indicator, program code transmits, in real-time, a (second) output to the classifier (240). If there are no indicators, the program code continues to obtain complementary data and evaluates these data with the machine learning models.

In some examples, the classifier receives the request, output from the first machine learning model, and the second machine learning model. As noted earlier, depending upon the sequencing or lack thereof of the first machine learning model and the second machine learning model, a classifier could classify a request as likely to be cancelled based on output from only one of the models. However, as illustrated in FIG. 2, which is an example of a workflow 200 of some examples, based on obtaining the request, the output from the first machine learning model, and/or the output from the second machine learning model, program code comprising the classifier determines, in real-time, a probability that the request will be cancelled (260). The program code makes this determination based on predetermined criteria.

As aforementioned, an advantage of the examples herein is that a user (who can be anyone involved in the processing of an order throughout the lifecycle of the order) can view a probability of an order being cancelled at any time. And the probability is continuously updated based on the program code applying the machine learning models and applying a classifier to the output of the machine learning models. In some examples, a dashboard is the graphical user interface (GUI) generated by the program code and updated by the program code. In some examples, the program code (continuously) updates a dashboard (GUI) to reflect the probability that the request will be cancelled (270). In some examples, the program code continuously updates the probability and the display as it receives data associated with at least one of the client, the request, the complementary data, and monitoring information, applies the relevant machine learning models to these data, transmits the output of the models to a classifier, and applies the classifier to compute new probabilities in real-time (using predetermined criteria) regarding whether the request will be cancelled.

FIG. 3 is an example of the classifier that can be generated by the program code and utilized in the examples herein to classify requests as meeting a given probability of being cancelled or not (using predetermined criteria, based on obtaining outputs from the machine learning models). The program code generates and trains the machine learning models to determine whether client data, request data, and complementary data contains patterns indicative of a propensity of being cancelled, when compared to historical patterns and to determine whether satellite or other weather or environmental data is indicative of conditions which would contribute to a possible cancellation of a service (requested). FIG. 3 is one example of a machine learning model with a classifier 300 that may be utilized, in one or more aspects, to generate and train resource models that can determine, based on the binary output provided by the machine learning models, that the requested telecommunications service has a given probability of being cancelled before it is provided (or does not have this probability).

In this example, the program code can be trained to classify requests as either having a given probability of being cancelled or not having this probability. FIG. 3 is one example of a machine learning model with a classifier 300 that may be utilized, in one or more aspects, to perform cognitive analyses of various inputs, including the outputs of the machine learning models and/or the data utilized by these models (in some examples), which can include, but is not limited to, an identifier of the requestor, data related to the request, complementary data obtained that is relevant to the request, historical order and cancellation data, weather and climate data related to the service area in which the request is being serviced during an available service window, etc. (collectively referred to as the inputs). The program code in embodiments of the present invention performs a cognitive analysis to generate one or more training data structures, including the aforementioned machine learning models, which can include algorithms utilized by the program code to analyze the request, based on the inputs. Machine learning (ML) solves problems that are not solved with numerical means alone. In the first machine learning model (which utilizes historical data), the program code can extract various attributes from the historical data. In the second machine learning model, the program code can extract attributes from the weather and climate data. In both cases, the program code can utilize these attributes 315 (extracted by both models) to develop a predictor or classifier function, h (x), also referred to as a hypothesis, which the program code utilizes as a machine learning model 330. In some embodiments, the input to the classifier is the binary output from each of the machine learning models.

In identifying various features and/or parameters indicative of whether a given request has a threshold probability of being cancelled in the ML training data 310, the program code can utilize various techniques to identify attributes in an embodiment of the present invention. Embodiments of the present invention utilize varying techniques to select attributes (elements, patterns, features, components, etc.), including but not limited to, diffusion mapping, principal component analysis, recursive feature elimination (a brute force approach to selecting attributes), and/or a Random Forest, to select the attributes related to various events. The program code may utilize a machine learning algorithm 340 to train the machine learning model 330 (e.g., the algorithms utilized by the program code), including providing weights for the conclusions, so that the program code can train the predictor functions that comprise the machine learning model 330. The conclusions may be evaluated by a quality metric 350. By selecting a diverse set of ML training data 310, the program code trains the machine learning model 330 to identify and weight various attributes (e.g., features, patterns, components) that correlate to requests and whether those requests were cancelled before being fulfilled.

The model generated by the program code can be self-learning as the program code updates the model based on active feedback, as well as from the feedback received from data related to the request (e.g., in the telecommunications order system). For example, when the program code determines that there is information that was not previously predicted or classified by the model, the program code utilizes a learning agent to update the model to improve classifications in the future. Additionally, when the program code determines that a classification is incorrect, either based on receiving user feedback through an interface or based on monitoring in the telecommunications system, the program code updates the model to reflect the inaccuracy of the classification for the given period of time. Program code comprising a learning agent cognitively analyzes the data deviating from the modeled expectations and adjusts the model to increase the accuracy of the model, moving forward.

FIG. 4 is a combination workflow and technical architecture diagram 400 that provides additional details related to some examples herein. The workflow illustrates various aspects, including but not limited to, program code executing on more or more processors verifying and correcting inconsistent data throughout the use of RPAs, APIs, and crawlers to interact with external data. The program code can also utilize a cognitive assistant (e.g., chatbot) to interact with the customer in case of inconsistent data. The chatbot can request that a user confirm inconsistent data, including but not limited to, a postal code or a vanity address when a proper name is indicated. The workflow illustrates how the program code predicts a probability of a given sales order being cancelled prior installation and continuously updates the probability while the sales order flows through the sales pipeline and processes. Through these updates, the program code generates a visualization of these data in a GUI, such as a dashboard. The program code displays information pertinent to the order (and the most current information pertinent to the order) on the dashboard. In some examples, if the program code determines that the probability of cancellation of an order is at a given threshold or at a given threshold for a given amount of time, the program code can automatically cancel the order.

As illustrated in the workflow and technical architecture diagram 400, in this example, program code, executed by one or more processors, initially obtains a sales order from a seller (410). The program code verifies the data comprising the order including correcting incorrect data (420). To verify the order data, the program code can check components of the order, including but not limited to, the region, the request, availability, etc. The program code can utilize external databases and services (e.g., address verification software) to check data in the order and correct data that is incorrect (430). To check the veracity of the data in the order, the program code can query one or more data sources 405, including not limited to databases with client information and company data, such as historical sales orders, user data from the client, infrastructure data information, etc. In some examples, the program code can check the data (including corrected data from data from the data sources 405) by initiating a chat with the client via a chatbot 415. In some examples, the data sources 405 are data sources internal to the system. The program code can utilize a chatbot 415 to interact with a user to complete the information, if needed. In some examples, a representative of the telecommunications company whose system obtained the order can manually utilize the chatbot 415. In some examples, the chatbot 415 is automated (e.g., it is an AI assistant).

The program code obtains complementary data including satellite images from one or more external data sources 425 to enhance the request data (430). These external sources can include, but are not limited to, social networks, government data, development index, postal code data, satellite images, etc. The program code obtains satellite images relevant to weather in a geographic area identified in the order.

The program code applies machine learning models to the corrected data and the complementary data; the latter include the satellite images (440). In this example, the program code applies two machine learning models, which serve to provide information to a classifier (e.g., FIG. 3) which enables the classifier to predict a probability of the order being cancelled or not. As discussed in FIG. 2, a first machine learning model can utilize data related to the order itself and generate output that identifies aspects that indicate a propensity for the order being cancelled or not being cancelled. Meanwhile, the second machine learning model analyzes environmental (e.g., weather) information to produce outputs that identifies aspects that indicate a propensity for the order being cancelled or not being cancelled.

In some examples, the first machine learning model is a natural language processing (NLP) model. The NLP model can be based on a transformer model (e.g., IBM CognosR Transformer), which is a metadata modeling tool that can be used to create cognitive decision-making blocks that can be utilized by machine learning algorithms. In examples herein, the NLP model can be provided with data from social media networks data collected, for example, by a crawler via APIs and RPAs. One or more embodiments of the present disclosure can utilize IBM WatsonR NLP. Cognos and Watson are trademarks or registered trademarks of International Business Machines Corporation in at least one jurisdiction. The program code in the examples herein can utilize IBM WatsonR NLP or other NLP algorithms or models to analyze text (e.g., the text of the order and the aforementioned complementary data) to infer certain conditions that would result in a cancellation (based on historical data) through syntax analysis by utilizing pretrained and custom models. For example, the program code can assign a higher score to a given parameter in the text (e.g., an address, a time of day the order was places, a public comment on a social media post made by the individual placing the order) based on the prevalence of keywords or phrases that indicate these parameters (in accordance with a pre-trained model and/or dataset). In some examples, the program code can assign a higher score to a parameter based on a rating associated with the keyword that indicates the context of the parameter associated with the keyword or phrase. The program code in embodiments of the present disclosure can identify patterns in text that indicate patterns in cancelled orders and can weight these various patterns to indicate a likelihood (e.g., on a pre-defined scale) an order will be cancelled based on this pattern.

In some embodiments of the present invention, the second machine learning model, which can obtain satellite images as input, is a computer vision (CV) model on a CNN architecture. The program code can input satellite images and the model can output environmental impeditive conditions. A CV model is a processing block that takes uploaded inputs, like images or videos, and in this example, satellite images, and predicts or returns pre-learned concepts or labels, in this example, impeditive conditions to order (service) delivery. By utilizing a CV model with a CNN, enables the fine-tuning of large amounts of parameters and massive pre-labeled datasets. Because satellite images can be dense (data-wise) utilizing a CV model with a CNN enables the program code to obtain impeditive conditions from a complex dataset (e.g., the images) with speed and accuracy that allows the program code to contribute data that enabled a classifier to consistently update a prediction regarding whether the order is likely to be cancelled (e.g., on a pre-established scale) while the order is working through the order entry system.

Returning to FIG. 4, based on applying the machine learning models to the corrected data, the complementary date, and to the satellite images, the program code obtains output from the models, including indicators relevant to cancellation of the order (450). In some examples, the first machine learning model identifies parameters (and can impose weighted parameters) indicative of a possible or probable order cancellation, while the second machine learning model outputs impeditive conditions to providing services to the requested order location. The program code applies a classifier to the outputs to classify the order as having a threshold probability of being cancelled or not being cancelled before fulfillment (460). The classifier can be part of the program code. The classifier can be a binary classifier. Because the collection of data affecting the classifier is ongoing (complementary data and satellite images), the classifier can continuously classify a given order and update this classification throughout the lifecycle of the order.

The program code generates and/or updates an interface (e.g., a dashboard 435) to indicate results of a most recent classification of an order by the program code (utilizing the classifier) (470). The dashboard provides a follow up mechanism to follow the probabilities of each sales order being cancelled. The dashboard can include visualizations of sales requests and order tracking. In some examples, the program code can automatically cancel an order that remains in at a cancellation probability under certain circumstances, including over the course of a certain amount of time. In some examples, the program code can track an order to determine whether a prediction came to fruition and can update historical data (which is used as training data for at least one machine learning model) to reflect the result. Thus, the machine learning models herein can be continuously trained by the program code and will become more accurate through usage.

Embodiments of the present invention include computer-implemented methods, computer program products, and computer systems that include program code executed on one or more processors that continuously predicts order cancellation in real-time. In some examples, the program code obtains, via a client, an order for a service to be performed at a physical location. The program code verifies data comprising the order. The program code continuously obtains complementary data to the verified order data; the complementary data comprises satellite images of one or more locations relevant to the physical location. The program code continuously applies one or more machine learning models to input comprising the complementary data and the verified order data to produce output comprising one or more indicators that the order will be cancelled before the service is performed. Based on obtaining the output, the program code continuously transmits the one or more indicators to a classifier. The program code continuously applies the classifier to generate a prediction at a threshold probability, based on the one or more indicators, that the order will be cancelled before the service is performed. The program code continuously generates or updates a graphical user interface comprising a dashboard on a display accessible to the one or more processors, to reflect a status of the order, wherein the status comprises the determination of the classifier.

In some examples, the one or more machine learning models comprise a natural language processing model, and the program code continuously applying comprises continuously applying the natural language processing model to the verified order data and to at least a portion of the complementary data.

In some examples, the one or more machine learning models comprise a computer vision model, and the program code continuously applying comprises continuously applying the computer vision model to the satellite images of one or more locations.

In some examples, an infrastructure of the computer vision model comprises a convolutional neural network.

In some examples, the program code trains the one or more machine learning models with historical order data.

In some examples, the program code verifies the data by identifying at least one inconsistency in the data, accessing at least one data source selected from the group consisting of: client information, company data, historical sales orders, user data, and infrastructure data, to check the at least one inconsistency against the data source, and updating the at least one inconsistency based on the accessing.

In some examples, the program code verifying the data comprising the order include the program code generating a chatbot to interact with the client. The program code provides, via the chatbot, the updated at least one inconsistency to request a user verify the updated at least one inconsistency. The program code obtains, via the chatbot, a response. The program code determines based the response, whether to revert the updated at least one inconsistency to an original state before the continuously obtaining.

In some examples, the program code continuously obtaining the complementary data comprises the program code mining the complementary data from one or more external data sources.

In some examples, the program code mining comprises the program code utilizing tools selected from the group consisting of: robotic process automations, application programming interfaces, and crawlers to access the one or more external data sources.

In some examples, the external data comprise data sources are selected from the group consisting of: social networks, government databases, development indexes, postal code databases, and satellite image databases.

In some examples, the program code determines that a lifecycle of the order is complete. Based on making this determination, the program code can terminate the continuously updating, the continuously applying the one or more machine learning models, the continuously transmitting, the continuously applying the classifier, and the continuously generating or updating.

In some examples, the program code determining that the lifecycle is complete comprises the program code obtaining order data indicating that the order is in a status selected from the group consisting of: complete and cancelled.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of continuously predicting order cancellation in real-time, the method comprising:
obtaining, by one or more processors, via a client, an order for a service to be performed at a physical location;
verifying, by the one or more processors, data comprising the order;
continuously obtaining, by the one or more processors, complementary data to the verified order data, wherein the complementary data comprises satellite images of one or more locations relevant to the physical location;
continuously applying, by the one or more processors, one or more machine learning models, to input comprising the complementary data and the verified order data, to produce output comprising one or more indicators that the order will be cancelled before the service is performed;
based on obtaining the output, continuously transmitting, by the one or more processors the one or more indicators to a classifier;
continuously applying, by the one or more processors, the classifier to generate a prediction at a threshold probability, based on the one or more indicators, that the order will be cancelled before the service is performed; and
continuously generating or updating, by the one or more processors, a graphical user interface comprising a dashboard on a display accessible to the one or more processors, to reflect a status of the order, wherein the status comprises the determination of the classifier.

2. The computer-implemented method of claim 1, wherein the one or more machine learning models comprise a natural language processing model, and wherein the continuously applying comprises continuously applying the natural language processing model to the verified order data and to at least a portion of the complementary data.

3. The computer-implemented method of claim 1, wherein the one or more machine learning models comprise a computer vision model, and wherein the continuously applying comprises continuously applying the computer vision model to the satellite images of one or more locations.

4. The computer-implemented method of claim 3, wherein an infrastructure of the computer vision model comprises a convolutional neural network.

5. The computer-implemented method of claim 1, further comprising:
training, by the one or more processors, the one or more machine learning models with historical order data.

6. The computer-implemented method of claim 1, wherein verifying the data comprising the order comprises:
identifying, by the one or more processors, at least one inconsistency in the data;
accessing, by the one or more processors, at least one data source selected from the group consisting of: client information, company data, historical sales orders, user data, and infrastructure data, to check the at least one inconsistency against the data source; and
updating, by the one or more processors, the at least one inconsistency based on the accessing.

7. The computer-implemented method of claim 6, wherein verifying the data comprising the order further comprises:
generating, by the one or more processors, a chatbot to interact with the client;
providing, by the one or more processors, via the chatbot, the updated at least one inconsistency to request a user verify the updated at least one inconsistency;
obtaining, by the one or more processors, via the chatbot, a response; and
determining, by the one or more processors, based the response, whether to revert the updated at least one inconsistency to an original state before the continuously obtaining.

8. The computer-implemented method of claim 1, wherein continuously obtaining the complementary data comprises:
mining, by the one or more processors, the complementary data from one or more external data sources.

9. The computer-implemented method of claim 7, wherein the mining comprises utilizing tools selected from the group consisting of: robotic process automations, application programming interfaces, and crawlers to access the one or more external data sources.

10. The computer-implemented method of claim 7, wherein the external data comprise data sources are selected from the group consisting of: social networks, government databases, development indexes, postal code databases, and satellite image databases.

11. The computer-implemented method of claim 1, further comprising:
determining, by the one or more processors, that a lifecycle of the order is complete; and
based on the determining, terminating, by the one or more processors, the continuously updating, the continuously applying the one or more machine learning models, the continuously transmitting, the continuously applying the classifier, and the continuously generating or updating.

12. The computer-implemented method of claim 11, wherein the determining that the lifecycle is complete comprises:
obtaining, by the one or more processors, order data indicating that the order is in a status selected from the group consisting of: complete and cancelled.

13. A computer system for predicting order cancellation in real-time, the computer system comprising:
a memory; and
one or more processors in communication with the memory, wherein the computer system is configured to perform a method, said method comprising:
obtaining, by the one or more processors, via a client, an order for a service to be performed at a physical location;
verifying, by the one or more processors, data comprising the order;
continuously obtaining, by the one or more processors, complementary data to the verified order data, wherein the complementary data comprises satellite images of one or more locations relevant to the physical location;
continuously applying, by the one or more processors, one or more machine learning models, to input comprising the complementary data and the verified order data, to produce output comprising one or more indicators that the order will be cancelled before the service is performed;
based on obtaining the output, continuously transmitting, by the one or more processors the one or more indicators to a classifier;
continuously applying, by the one or more processors, the classifier to generate a prediction at a threshold probability, based on the one or more indicators, that the order will be cancelled before the service is performed; and
continuously generating or updating, by the one or more processors, a graphical user interface comprising a dashboard on a display accessible to the one or more processors, to reflect a status of the order, wherein the status comprises the determination of the classifier.

14. The computer system of claim 13, wherein the one or more machine learning models comprise a natural language processing model, and wherein the continuously applying comprises continuously applying the natural language processing model to the verified order data and to at least a portion of the complementary data.

15. The computer system of claim 13, wherein the one or more machine learning models comprise a computer vision model, and wherein the continuously applying comprises continuously applying the computer vision model to the satellite images of one or more locations.

16. The computer system of claim 15, wherein an infrastructure of the computer vision model comprises a convolutional neural network.

17. The computer system of claim 13, further comprising:
training, by the one or more processors, the one or more machine learning models with historical order data.

18. The computer system of claim 13, wherein verifying the data comprising the order comprises:
identifying, by the one or more processors, at least one inconsistency in the data;
accessing, by the one or more processors, at least one data source selected from the group consisting of: client information, company data, historical sales orders, user data, and infrastructure data, to check the at least one inconsistency against the data source; and
updating, by the one or more processors, the at least one inconsistency based on the accessing.

19. A computer program product predicting order cancellation in real-time, the computer program product comprising:
one or more computer readable storage media and program instructions collectively stored on the one or more computer readable storage media readable by at least one processing circuit to:
obtain, by the one or more processors, via a client, an order for a service to be performed at a physical location;
verify, by the one or more processors, data comprising the order;
continuously obtain, by the one or more processors, complementary data to the verified order data, wherein the complementary data comprises satellite images of one or more locations relevant to the physical location;
continuously apply, by the one or more processors, one or more machine learning models, to input comprising the complementary data and the verified order data, to produce output comprising one or more indicators that the order will be cancelled before the service is performed;
based on obtaining the output, continuously transmit, by the one or more processors the one or more indicators to a classifier;
continuously apply, by the one or more processors, the classifier to generate a prediction at a threshold probability, based on the one or more indicators, that the order will be cancelled before the service is performed; and
continuously generate or update, by the one or more processors, a graphical user interface comprising a dashboard on a display accessible to the one or more processors, to reflect a status of the order, wherein the status comprises the determination of the classifier.

20. The computer program product of claim 19, wherein the one or more machine learning models comprise a natural language processing model, wherein the continuously applying comprises continuously applying the natural language processing model to the verified order data and to at least a portion of the complementary data, wherein the one or more machine learning models comprise a computer vision model, and wherein the continuously applying comprises continuously applying the computer vision model to the satellite images of one or more locations.
